(19) United States
(12) Patent Application Publication
(10) Pub. No.: US 2022/0174893 A1
(43) Pub. Date: Jun. 9, 2022

(54) HEMP HARVESTING METHOD AND APPARATUS

(71) Applicant: Roger Moore, Waldron, IN (US)

(72) Inventor: Roger Moore, Waldron, IN (US)

(21) Appl. No.: 17/115,039

(22) Filed: Dec. 8, 2020

(51) Int. Cl. A01G 17/02

(52) U.S. Cl. CPC A01G 17/026

(57) ABSTRACT

A method for harvesting hemp, including first identifying a hemp stripper machine including a frame having a front side, an oppositely disposed ejection side, and an access side extending therebetween; a roller drum assembly rotatably mounted within the frame and further comprising a weighted cylindrical drum; and a plurality of elongated brush heads operationally connected to the weighted cylindrical drum; wherein the brush heads are staggered about the drum; a pivotable cradle table extending from the front side; an access opening on the front side for feeding hemp through to the roller drum assembly; a motor operationally connected to the roller drum assembly; and an ejection port on the ejection side, positioned to receive harvested hemp from the roller drum assembly, then energizing the motor, guiding a hemp plant portion through the access opening and into the roller drum assembly, removing seeds and leaves from the hemp plant portion, expelling hemp seeds and leaves through the ejection port, and collecting hemp seeds and leaves as expelled through the ejection port;

### TECHNICAL FIELD

The present disclosure relates generally to agriculture, and more particularly, to an industrial harvesting system.

### BACKGROUND

The United States has seen an enormous increase in hemp crops over the past few years, and for good reason. Hemp is an extremely versatile and sustainable crop that offers farmers a variety of great benefits. For example, hemp is a highly robust crop that can grow almost anywhere in the United States. Hemp also offers farmers a substantial return on investment allowing them the opportunity to create a sustainable business and lifestyle. While considering hemp farming appears to be promising, issues unfortunately arise during harvest season due to the antiquated state of the currently available harvesting machines.

Current methods and devices available for stripping useful hemp seeds and leaves from hemp branches and stems are expensive, inefficient, and potentially dangerous as they require the application of excessive power and energy during operation. Further, machines currently available are overly complex and feature a great deal of rotating parts, which inevitably leads to an increase in injuries, mechanical failures, and expensive repairs. Moreover, stripping machines are notorious for hanging onto residual stems which prevents the machines from collecting desired and useful pieces of the hemp plant. Excess waste on the drum can also cause the machine to jam and poses safety concerns to those operating the machine.

It is evident that there is a continuing need for a harvesting machine that is less financially burdensome and prone to breakdown. A machine that is cheaper, safer, and effective in stripping hemp seeds from hemp plants is needed. The present technology addresses this need.

### SUMMARY

In one aspect, a cost-effective hemp stripping machine that features staggered brushes to apply intermittent pressure to hemp plants to dislodge and collect desired leaves and seeds, thus decreasing the likelihood of safety mishaps and/or frequency of mechanical breakdowns, is described. A deconstructed yard roller (a cylindrical yard tool that is filled with added weight, typically sand or water, for flattening the ground) may be used as a rotatable drum and may be inserted into a side opening of a large frame. Once the drum is secured inside the frame, broom heads—essentially lengthened brushes—may be positioned about the drum such as in a staggered or alternating pattern. The brushes provide a gripping force for efficiently stripping the hemp plant of its leaves and/or seeds. A pivotable cradle table is mounted to the front or anterior side of the frame and used to guide the hemp plants through the machine. An ejection shute is implemented on the back or posterior side of the frame, which guides the plucked leaves and/or seeds into a collection container or a pile on the floor or ground.

In another aspect, a method for using the above hemp stripping machine is provided. The stripping functions of the device may be initiated when an operator powers on the machine. The operator may place a branch of a hemp plant on the pivot-mounted cradle table and guide said plant into the opening of the frame that houses the roller drum assembly. The spinning nature of the drum allows the brushes to rotate. Because of the intentional staggered placement of the brushes, an intermittent or alternating pressure is applied to the plant which is stripped of its valuable or desired resources, notably the hemp seeds and leaves. These resources are then collected in a manner convenient to the operator. Once finished, the machine may be powered down.

### BRIEF DESCRIPTION OF THE DRAWINGS

FIG. 1 is a side view of a yard roller, according to a first embodiment.

FIG. 2 is a perspective view of the brushes bolted to a drum, according to the embodiment of FIG. 1.

FIG. 3 is side view of the frame where a drum slides through a side opening and into position, according to the embodiment of FIG. 1.

FIG. 4 is a direct view of a drum positioned within the frame, according to the embodiment of FIG. 1.

FIG. 5 is a left side view of a pivot-mounted cradle table, according to the embodiment of FIG. 1.

FIG. 6 is an overhead view of the cradle table, according to one embodiment, according to the embodiment of FIG. 1.

FIG. 7 is a rear-facing perspective view of the assembly, according to the embodiment of FIG. 1.

FIG. 8 is a perspective view of the cradle table, according to the embodiment of FIG. 1.

FIG. 9 is a forward-facing perspective view of the assembly, according to the embodiment of FIG. 1.

FIG. 10 is a direct view of a 110 volt battery used to power the machine, according to the embodiment of FIG. 1.

### DETAILED DESCRIPTION

For the purposes of promoting an understanding of the principles of the novel technology and presenting its currently understood best mode of operation, reference will now be made to the embodiments illustrated in the drawings and specific language will be used to describe the same. It will nevertheless be understood that no limitation of the scope of the novel technology is thereby intended, with such alterations and further modifications in the illustrated device and such further applications of the principles of the novel technology as illustrated therein being contemplated as would normally occur to one skilled in the art to which the novel technology relates.

As used in the specification and the claims, the singular forms “a,” “an” and “the” include plural referents unless the context clearly dictates otherwise. Ranges may be expressed in ways including from “about” one particular value, and/or to “about” another particular value. When such a range is expressed, another implementation may include from the one particular value and/or to the other particular value. Similarly, when values are expressed as approximations, for example by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. Similarly, “typical” or “typically” means that the subsequently described event or circumstance often though may not occur, and that the description includes instances where said event or circumstance occurs and instances where it does not.

FIGS. 1-10 relate to a hemp harvesting apparatus and method for using the same. The hemp stripping machine 1 has a front side 33, a typically oppositely disposed ejection side 31, and an access side 32 typically extending therebetween, and further contains a plurality of brushes 15 attached to a roller drum 5. Referring to FIG. 1, there is shown roller drum 5 before brushes 15 are attached.

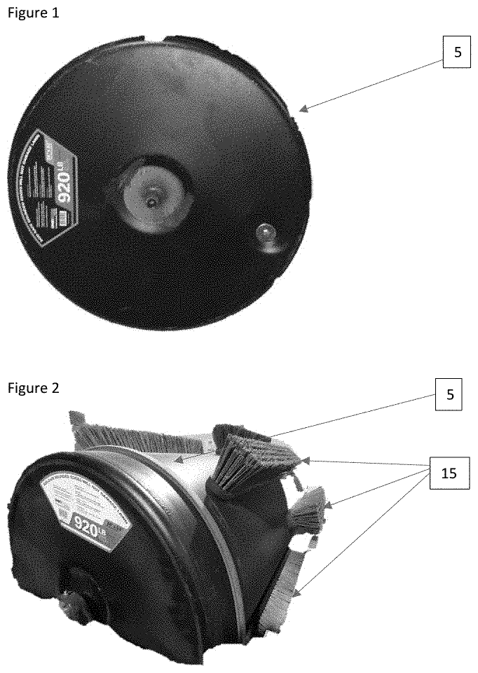

In reference to FIG. 2, there are shown multiple rough surface brushes 15 operationally connected to drum 5. An ordinary push broom typically used in a house or garage may be deconstructed so that that handle end is separated from the brush end. The brush end is typically comprised of a multitude of bristles attached to one side of an elongated broom head. The oppositely disposed surface is adapted to lockingly accept an elongated handle. Broom heads are typically made of durable materials, such as wood or plastic. In one embodiment, the handle of a push broom may be detached from the brush end 15 and said brush end 15 may be attached to the drum 5. Typically, a plurality of brushes 15 may be connected to roller drum 5, typically oriented so that drum 5 remains balanced when rotated. Attachment of the brushes 15 to roller drum 5 defines roller drum assembly 25. Brushes 15 may be all of one length or of a number of different lengths. Brushes 15 are typically about ten centimeters wide at the widest point and ten centimeters deep. The bristles on brushes 15 are typically made of stiff synthetic material, such as nylon or polyester but may likewise be made of natural materials, including animal hair or stiff grasses. Bristles may be flagged or unflagged, depending on the needs of the operator. Brushes 15 are intentionally staggered on the roller drum 5 so the pressure applied to the plant material during operation is intermittent instead of continuous. This intentional staggered placement of brushes 15 reduces physical stress experienced by an operator by reducing the grip pressure required while holding and inserting the plant, into machine 1.

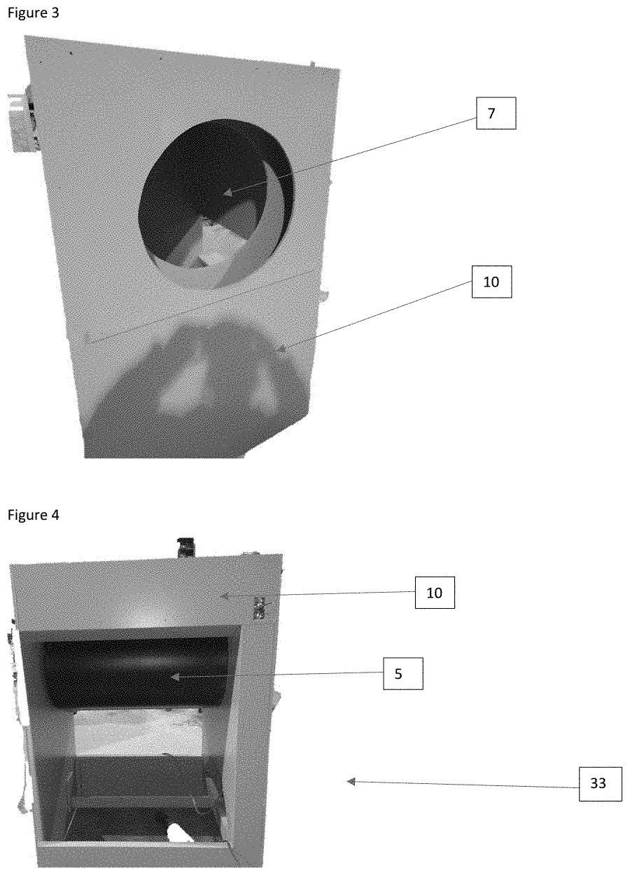

Referring to FIG. 3, there is shown a side view of the frame 10 which houses the roller drum assembly 25. The roller drum 5 slides through the side opening 7 to operationally connect to a rotor/pulley. Brushes may be attached prior to mounting the roller drum 5 inside the frame 10, or afterward. Once the roller drum assembly 25 is mounted in place, a removable cover plate 6 may be placed over the side opening 7 to close it off, as seen in FIG. 7. The removable cover plate 6 makes the roller drum assembly 25 easily accessible for maintenance and repair. Frame 10 is typically made of solid, durable material, such as stainless steel, aluminum, or the like. Removable cover plate 6 may be made of the same material as the frame 10. Referring to FIG. 4, there is shown a front-view of the frame 10 with roller drum 5 positioned into the frame 10 and ready for the brushes 15 to be attached.

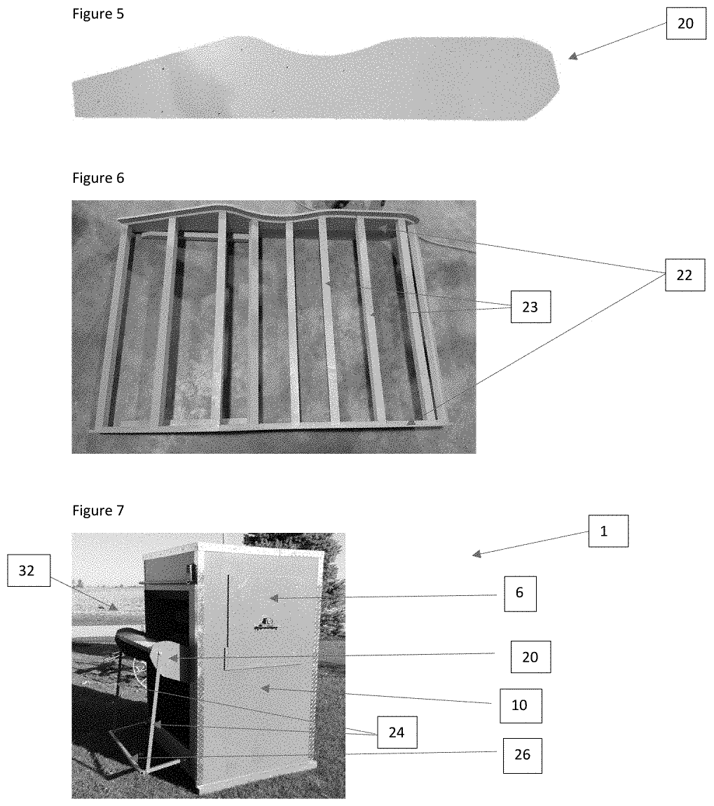

Referring to FIG. 5, there is shown a left side view of the pivot mounted cradle table 20, which is also created out of durable, solid material similar to frame 10. Cradle table 20 may be the same radius as the drum 5 or other appropriate sizes. The length of the cradle table 20 may be between sixty-one inches to sixty-five inches, and more likely between sixty-three and one-half inches and sixty-four inches. The width of the cradle table 20 may be between forty inches and forty-five inches, and more likely between forty-one inches and forty-one and three-fourths inches. Notably, however, these ranges are not meant to be limiting, as any size combination of the roller drum assembly 25 and cradle table 25 may be used.

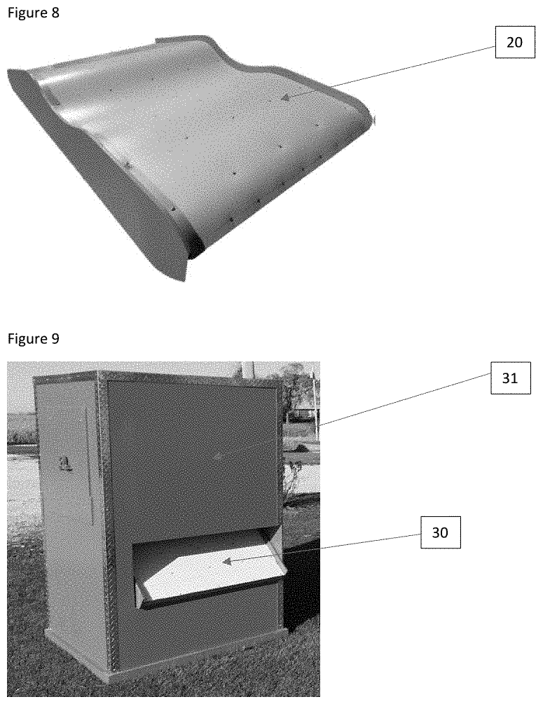

Referring to FIG. 6, there is shown an above-view of a cradle table frame 21 of the cradle table 20 before durable materials are added and before the cradle table 20 is ready to be used. The cradle table frame 21 includes a plurality of spar braces 23, typically evenly spaced between two longitudinal bracing side walls 22. The spar braces 23 are encased with PVC plastic sheet material, which provides a durable yet smooth surface that is resistant to the friction from the bristles of the brushes 15. Referring to FIG. 8, there is shown a cradle table 20 that is ready to be attached to the frame 10.

FIG. 7 shows cradle table 20 attached to the access side 32 of the frame 10. The cradle table 20 has a curved portion for accepting the roller drum 22. This contoured shape also impacts the efficiency of the machine as the unique shape of the table 20 allows for an even pressure to be applied to the plant while the plant is fed through an access opening 16. This allows only a thin, single-line point of contact between the plant and the brush which facilitates a more efficient stripping process. In one embodiment, the cradle table 20 may be mounted to the frame 10 so that a portion of the table 20 remains outside of the frame 10 and is accessible by an operator. Further, the table 20 may be mounted on a pivot point 27 which provides best balance for tilting the table 20 prior to inserting plants and during the stripping process. The pivotable nature of the table 20 allows the correct amount of pressure to be applied to the plant during the stripping process. Once the table 20 is mounted about the frame 10, the table 20 may be fully supported by attaching support legs 24 to each side of the table 20. Attached to both legs 24 may be a horizontal support bar 26. The multipurpose horizontal support bar 26 provides further support for the table 20 and is also pressure-operated so that the operator may use their foot to raise, lower, or tilt the table 20. The pivotable nature of the table 20 also accommodates varying sizes of plants. For example, if the operator feeds a larger plant into the machine 1, he or she may apply pressure to the horizontal support bar 26 to widen the gap between the pivot table 20 and the roller drum assembly 25 so that the larger plant may fit into the machine 1. If desirable, the table 20 may also be raised, lowered, or tilted by the operator's hand. Placement of the horizontal support bar is subject to the operator's discretion.

Referring to FIG. 9, there is shown an ejection shute 30. Once the plant has been inserted into the machine and stripped of its valuable materials, the valuable materials exit the machine through an ejection shute 30 located on the ejection side 31 of the frame 10 and operationally centered thereto. The ejection side 31 is on the side oppositely disposed from the cradle table 20. At the ejection side 31 and underneath the ejection shute 30, the stripped materials may pile onto the ground or floor, into a collection container, or onto a conveyor belt.

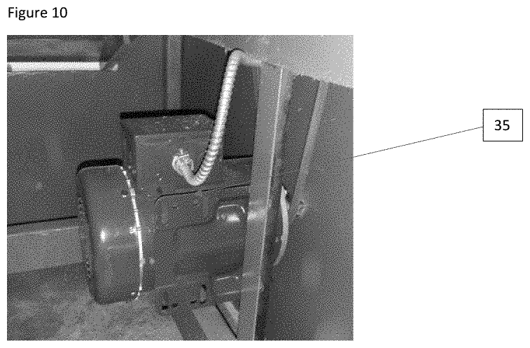

Referring to FIG. 10, there is shown a motor 35 for spinning the drum 5. The motor 35 may be powered by 110-volt single phase electricity common household or line electricity. Higher voltage is not needed because of the low current requirements and small load on the motor 35, however, motor 35 may be of any size and power desired by the operator. The actuator 36 may be located on the motor 35 and may be controlled by the operator.

Generally, another important safety feature found insofar that the belt drive within the hemp stripper 1 is typically connected loosely enough to disengage from the roller assembly 25 and immediately stop if the operator's hand, glove, or other object gets pulled inside the machine 1. Further, an emergency stop button is located on the face of the frame 10 which interrupts the motor if actuated. These safety features reduce the likelihood of injuries occurring during use of this hemp stripper 1. In some embodiments, motor 35 is operationally connected to rotor 37 such that energization of the motor 35 urges the rotor 37 to spin, rotating the drum 5 connected thereto. In other embodiments, energized motor 35 turns a first rotatable pulley 39 that is connected to an endless belt 38, wherein the belt 38 is operationally connected to and rotates drum 5 through a second pulley 41 operationally connected thereto.

The present description is for illustrative purposes only and should not be construed to narrow the breadth of the present disclosure in any way. Thus, those skilled in the art will appreciate that nigh-infinite modifications might be made to the presently disclosed embodiments without departing from the full and fair scope and spirit of the present disclosure. Other aspects, features, and advantages may be apparent upon an examination of the attached drawings and appended claims. As used herein, the articles “a” and “an” are intended to include on or more items and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

### LIST OF ELEMENTS

### Hemp Stripper Machine

1. hemp stripping machine
5. roller drum
6. removable cover plate
7. side opening
10. frame
15. brushes
16. feeder/access opening
20. pivot mounted cradle table
21. cradle table frame
22. side walls
23. spar braces
24. support legs
25. roller drum assembly
26. horizontal support bar
27. pivot point
30. ejection shute
31. ejection side
32. access side
33. front side
35. motor
36. actuator
37. rotor
38. belt
39. first pulley
41. second pulley

What is claimed is:

1. A hemp stripper machine comprising:
a frame having a front side, an oppositely disposed ejection side, and an access side extending therebetween;
a roller drum assembly rotatably mounted within the frame and further comprising:
a weighted cylindrical drum; and
a plurality of elongated brush heads operationally connected to the weighted cylindrical drum;
wherein the brush heads are staggered about the weighted cylindrical drum;
a pivotable cradle table pivotably connected to the frame and extending from the front side;
an access opening disposed on the front side for feeding hemp therethrough to the roller drum assembly;
a motor operationally connected to the roller drum assembly; and
an ejection port on the ejection side, positioned to receive harvested hemp from the roller drum assembly.

2. The hemp stripping machine of claim 1, wherein the pivotable cradle table extends from the front side of the frame; wherein the access side defines an opening for insertion of the roller drum and that can be covered with a removable cover plate connectable over the side opening; and wherein the ejection side of the frame defines an ejection shute.

3. The hemp stripping machine of claim 1, wherein the pivotable cradle table further comprises a cradle table frame that includes a multitude of structural spar braces equidistantly situated between at least two longitudinal side walls.

4. The pivotable cradle table of claim 4, further comprising of at least two support legs mounted to the longitudinal sides of the table.

5. The pivotable cradle table of claim 5, wherein a horizontal support bar is situated between the at least two support legs and positionable for optimal stripping.

6. A method for harvesting hemp, comprising:
a) identifying a hemp stripper machine including a frame having a front side, an oppositely disposed ejection side, and an access side extending therebetween; a roller drum assembly rotatably mounted within the frame and further comprising a weighted cylindrical drum; and a plurality of elongated brush heads operationally connected to the weighted cylindrical drum; wherein the brush heads are staggered about the drum; a pivotable cradle table extending from the front side; an access opening on the front side for feeding hemp through to the roller drum assembly; a motor operationally connected to the roller drum assembly; and an ejection port on the ejection side, positioned to receive harvested hemp from the roller drum assembly.
b) energizing the motor;
c) guiding a hemp plant portion through the access opening and into the roller drum assembly;
d) removing seeds and leaves from the hemp plant portion;
e) expelling hemp seeds and leaves through the ejection port; and
f) collecting hemp seeds and leaves as expelled through the ejection port;

7. The method of claim 6 and further comprising:
g) before c and after b), placing a portion of a hemp plant on a pivot-mounted cradle table; and
h) after f), de-energizing the motor.
